(19) United States
(12) Patent Application Publication
(10) Pub. No.: US 2025/0166096 A1
(43) Pub. Date: May 22, 2025

(54) Infrastructure Management Systems and Methods

(71) Applicant: Civil Lite, LLC, Muscle Shoals, AL (US)

(72) Inventors: William David Palmer, Russellville, AL (US); James Michael Hughes, Moulton, AL (US)

(73) Assignee: Civil Lite, LLC, Muscle Shoals, AL (US)

(21) Appl. No.: 18/516,141

(22) Filed: Nov. 21, 2023

(51) Int. Cl. G06Q 50/08; H04W 4/029

(52) U.S. Cl. CPC G06Q 50/08; H04W 4/029

(57) ABSTRACT

An infrastructure management system of the present disclosure has a handheld device that receives data indicative of one or more construction state numbers of one or more road segments, and the construction state numbers identify repair characteristics for classifying the one or more road segments for repair. Further, the infrastructure management system has a global positioning system (GPS) integral with or in communication with the handheld device that records coordinates of the handheld device for the one or more construction state numbers. In addition, the infrastructure management system has a processor configured for receiving data indicative of the one or more construction state numbers of the road segment and coordinates for the construction state numbers, the processor further configured for calculating dimensions of the construction state numbers based upon the coordinates, the processor further configured for calculating at least one cost scenario for each of the one or more road segments based upon the one or more construction states and the calculated dimensions.

### BACKGROUND

Presently, cities, states, and counties are responsible for construction and maintenance of roads. That is, state and local governments are responsible for the collection of data indicative of road, maintenance and/or repair of roads in their respective districts. These agencies may use different methods to assess transportation infrastructure. The agencies may use personnel for assessing transportation infrastructure via visual inspection or use of specialized equipment for imaging the state of a road segment.

As an example, pavement management systems that analyze road conditions of road segments may capture images of the pavement to detect defects. Often, the imagery is collected by personnel or contractors of the state and/or local governments. The imagery is analyzed by the personnel after collection, and certain metrics are determined based upon the analysis. The analysis may be performed using image processing and/or machine learning techniques. Results of the analysis may be used to determine, for example, work needed on a road segment and the cost of repairing, maintaining, or resurfacing the segment.

In some pavement management systems, a camera is mounted in a vehicle. The driver of the vehicle travels along road segments and collects the imagery of the road via the mounted camera on which the vehicle travels. The collected imagery is then analyzed, sometimes by personnel or automatically using the image processing techniques. These types of systems may not be accurate because the imagery captured may be affected by extraneous light sources, i.e. streetlights, light of oncoming vehicles, sunshine, or the like. Further, some road distresses are not readily identifiable by images alone, i.e., rideability may reveal distresses that are not otherwise detectable. Further, this process is time-consuming and may not capture a full picture of the condition of the road segment.

Finally, the most prevalent method, currently used, for pavement management requires physical measurements of distresses. State and/or local personnel or contractors are required to physically measure the geometric properties of distresses (lengths, widths, heights, etc.) identified during the inspection process. It takes an enormous amount of time to conduct this method of inspection and is highly labor intensive making it cost prohibitive for most agencies. Also, this method produces pavement condition indices and/or safety appraisal scales that are not specifically derived from the quantitative features of individual distresses. As a result, conversion of such ratings to cost estimates and methods of repair is very difficult, if not impossible.

### BRIEF DESCRIPTION OF THE DRAWINGS

The disclosure is better understood by referencing the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a diagram of a road infrastructure management system in accordance with an embodiment of the present disclosure.

FIG. 2 is a block diagram of an exemplary handheld device as shown in FIG. 1.

FIG. 3 is a block diagram of an exemplary remote server as shown in FIG. 2.

FIG. 4 is a diagram of an exemplary road segment farther illustrating exemplary construction state numbers recorded by a passenger as shown in FIG. 1 of the road segment.

FIG. 5 is table indicating construction state number indicated when using the system as shown in FIG. 1.

FIG. 6 is an exemplary table of pay items for a construction state number for use with the system as shown in FIG. 1.

FIG. 7 is an exemplary table indicating user-defined parameters of useful life and total life of a road segment.

FIG. 8 is a table indicating user-defined parameters for road construction index (RCI) weights for use with the system shown in FIG. 1.

FIG. 9 is a table indicating user-defined weights used in calculating priority scores and priority ranks for use with system shown in FIG. 1.

FIG. 10 is a flowchart exhibiting exemplary architecture and functionality of the handheld device as shown in FIG. 1.

FIG. 11 is a flowchart exhibiting exemplary architecture and functionality of the remote server calculating cost scenarios for the system as shown in FIG. 1.

FIG. 12 is a flowchart exhibiting exemplary architecture and functionality of the remote server calculating a user-defined cost scenario for the system as shown in FIG. 1.

FIG. 13 is a flowchart exhibiting exemplary architecture and functionality of the remote server prioritizing road segments for the system as shown in FIG. 1.

### DETAILED DESCRIPTION

The present disclosure describes an infrastructure management system and methods that are used by transportation professionals to develop project plans, specifications, and cost estimates. Specifically, the present disclosure relates to an infrastructure management system that produces the information for a government, such as a city, state, or county government, or a private entity that contracts with a government entity to manage the repair and/or maintenance of roads and/or bridges.

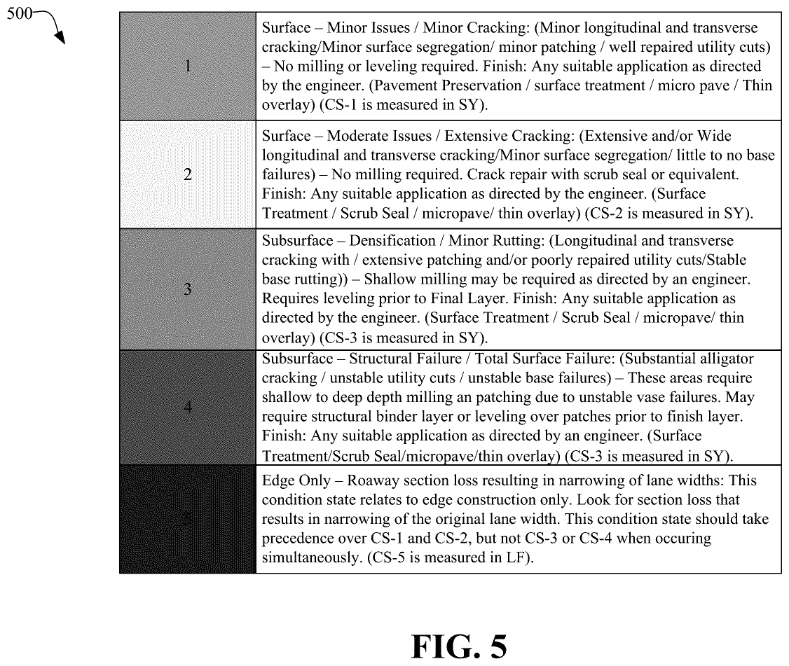

The infrastructure management system disclosed uses a handheld device for collecting data indicative of construction state numbers of a road segment. A construction state number is defined by an integer and relates to construction techniques and subsequent costs or repairs of a road segment. Construction state numbers are described further herein with reference to FIG. 5.

In one embodiment, the construction states are visually perceived by a passenger in a vehicle wherein the vehicle, driven by a driver, travels along a road segment. The passenger visually assesses the construction state(s) of the road segment and enters a numeric (integer) or an alphanumeric value via the handheld device representative of the construction state number. Note that a single road segment may possess various construction state(s), and the passenger, as visually inspected, enters each construction state number of the road segment as the vehicle travels along the road segment. Simultaneously there with, the handheld device automatically collects information related to the linear feet associated with the construction state numbers entered via a global positioning system (GPS) of the handheld device.

During travel along the road segment for the identified construction state number or after a road segment construction state number has been completed and each construction state number for the road segment entered, the handheld device transmits data indicative of the road segment construction state numbers and linear feet associated with the construction state numbers to a remote server via a network.

Upon receipt of data indicative of the construction state numbers and the linear feet associated with the construction state numbers, the remote server generates various metrics related to the road segment for which the data was collected. In one embodiment, the remote server may calculate an average construction state number based on each construction state number entered for the road segment. Further, the remote server may calculate surface area (e.g., square yards) of the road segment related to each identified construction state number. Notably, the surface area is dependent upon, for example, lane width.

From the surface area, the remote server calculates a road construction index (RCI), which is a calculated number (integer) indicative of the remaining life and probable repair cost of the road segment being analyzed based upon the construction state number(s) identified for the road segment. In one embodiment, the RCI calculated is used to prioritize or rank road segments. For example, a higher RCI indicates the road segment has a higher remaining adjusted life with a lower cost of repair. That is, where it lies in its life cycle and what it will cost to fix, or repair may be used to determine priority or rank. In another embodiment, average daily traffic (ADT) data associated with the road segment, the number of businesses or residences related to the road segment, and the RCI calculated related to the road segment, the remote server calculates a priority score for the road segment highest priority score to lowest priority score. In one embodiment, the remote server may generate a list itemizing each road segment from a high priority (i.e., the road segment requires a great deal of attention) to low priority (i.e., the road segment is not in need of as much attention). Further, the remote server may calculate a number indicative of the adjusted useful life remaining.

A user of the remote device may review information related to the road segment(s), e.g., the priority score, the adjusted useful life, etc. From the information calculated by the remote server, the user determines whether a road segment should be restored, rehabilitated, or reconstructed (RRR). Based upon the user's input, the remote device calculates a cost scenario for restoration, rehabilitation, or reconstruction, and provides the cost scenario to the user. Note that in one embodiment, the remote server may provide estimates related to the RR. The user may decide what course of action to take (i.e., restoration, rehabilitation, or reconstruction) based upon the proposed cost scenarios.

In one embodiment, the remote server may allow the user to select items for use in the RRR. For example, the user may choose “repair only.” If the user selects “repair only,” the remote server may display, for selection by the user, a list of pay items to be used in a repair only scenario. Such items may include, for example, material costs, labor costs, and the like. In such an embodiment, the user selects the pay items for a desired repair outcome.

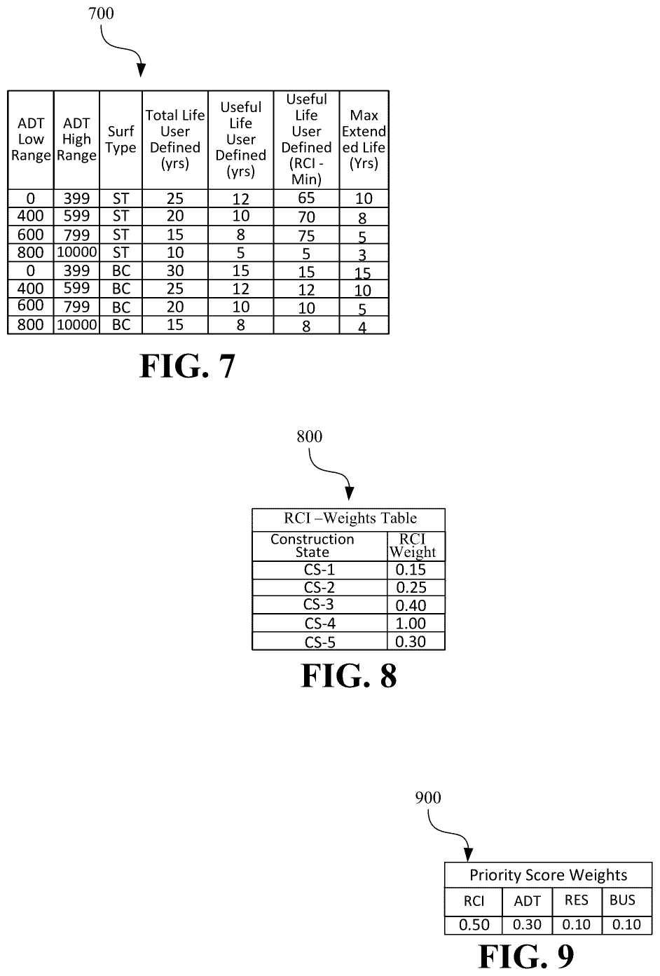

In another embodiment, the user may define user-defined weights stored as user-defined weight data 309 that the remote server uses in RCI calculations, prioritization calculations, and the like. Note that RCI calculations and prioritization calculations are merely examples. Other weights may be given by the user in other embodiments. Exemplary weights are shown with reference to FIGS. 7-9.

Based upon the information provided by the remote server, the user determines what road segments will be repaired, rehabilitated, or reconstructed. The user's determination may be based upon a budget by which the user desires to follow. Other factors that may be used in determining which road segments to repair, rehabilitate or reconstruct include priority rank, remaining useful life, and project cost, for example.

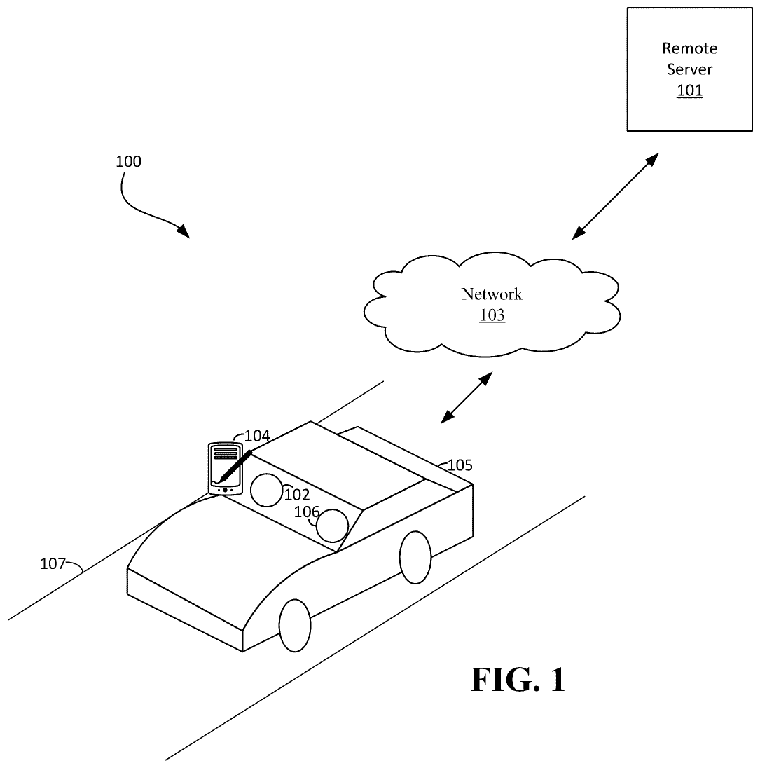

FIG. 1 is a diagram of an infrastructure management system 100 in accordance with an embodiment of the present disclosure. The infrastructure management system 100 comprises a handheld device 104 that is communicatively coupled with a remote server 101 via a network 103.

The remote server 101 is any type of computing device that is capable of receiving data and transmitting data through the network 103. The network 103 is any type of network capable of receiving information from the handheld device 104 and transmitting the data received to the remote server 101. Note that in one embodiment, the network 103 is a wireless network. Types of networks may include, but are not limited to, 3G, 4G, 5G, LAN, and WAN.

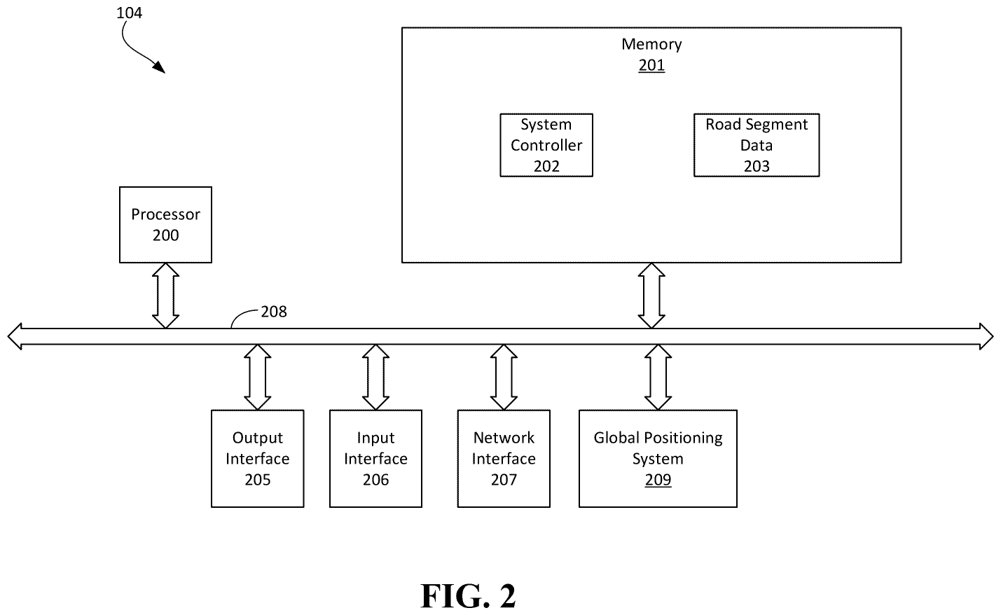

The handheld device 104 is any type of device that receives input from a passenger 102 of a vehicle 105. For example, the handheld device 104 may be a smartphone or a tablet. The handheld device 104 is further described with reference to FIG. 2.

In operation, the passenger 102 of the vehicle 105 operates the handheld device 104. The passenger 102 may provide identifying information to the handheld device 104 identifying a road segment. The identifying information may include a road segment identifier (segment ID), or the identifying information may include the name of a street, a road, etc. The current lane is also identified and input by the passenger 102 via the handheld device 104.

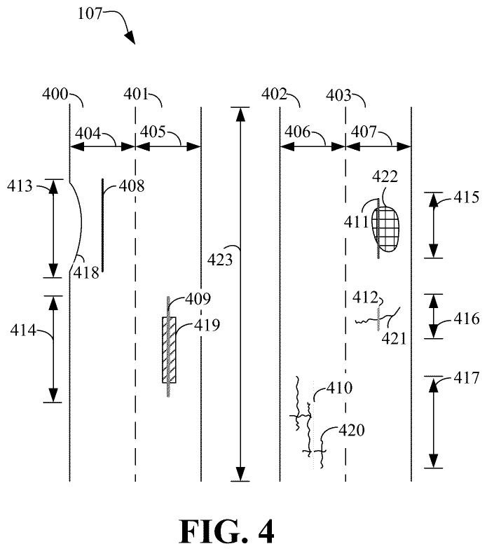

After identifying the road segment and lane number, the passenger 102 visually analyzes the current state of the road. In this regard, the passenger 102 may enter data identifying a construction state (CS) number of the road segment related to the road segment identifying information further described with reference to FIG. 4 in accordance with an embodiment of the present disclosure.

Note that each construction state number is represented by an integer 1-5. Thus, the passenger 102 visually analyzes the road segment 107 on which the vehicle is traveling. If the road segment 107 has only minor issues or minor cracking, the passenger enters 1. If the road segment 107 has moderate issues and/or extensive cracking, the passenger enters 2. If the road segment has subsurface-densification and/or minor rutting, the passenger 102 enters 3. If the road segment has subsurface structural failure and/or total surface failure, the passenger 102 enters 4, and if the road segment 107 has narrowing of lane widths (edge only), the passenger 102 enters 5.

The passenger 102 enters the construction state number, i.e., 1-5, as the driver 106 drives a vehicle 105 along the road segment 107. While the driver 106 is driving along the road segment 107, the handheld device 104 continuously records the coordinates of the current construction state number via a global positioning system (not shown) on the handheld device 104. Thus, for the construction state number entered, i.e., 1-5, the handheld device 104 creates a geographically correct line segment representing the current construction state number and associates the construction state number coordinates with the segment ID of the road segment 107.

If while driving along the road segment 107 the passenger 102 recognizes a change in the construction state number of the road segment 107, the passenger enters a different construction state number, i.e., 1-5. The GPS captures the coordinates of the changed construction state number and associates the changed construction state number with the segment ID of the road segment 107. This process repeats until all construction state number data has been collected for each lane of the road segment 107. In this regard, there may be one or more construction state number(s) for each road segment analyzed.

Once vehicle 105 has driven along each lane of the entire road segment 107, the handheld device 104 transmits data indicative of each construction state encountered along the road segment and associated coordinates to the remote server 101 via the network 103.

Upon receipt, the remote server 101 stores the data indicative of each construction state number and associates each construction state number with the corresponding data indicative of the coordinates for each construction state number. The remote server 101 calculates various metrics related to the road segment. In this regard, the remote server 101 translates the data indicative of the coordinates into linear feet and translates the linear feet for CS1-CS4 into square yards based on the lane width of the road segment 107. CS5 is a linear measurement and is not converted to square yards.

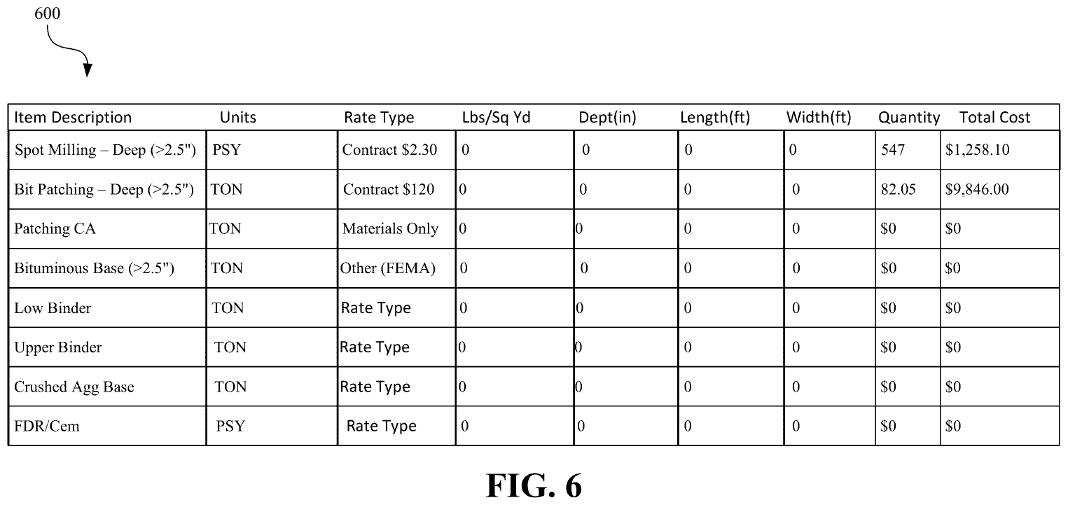

Once the conversion process is complete, the remote server 101 determines cost scenarios related to four different construction options to address distress or defects in a road segment including, but not limited to, “repair only (RO)”, “pavement preservation (PP)”, “mill and fill (M&F)”, and/or “reconstruction (RECON)”. In this regard, the remote system 101 calculates the cost scenarios based upon stored user defined cost scenario tables related to pay items pre-determined by the user that reflect material and labor data described with reference to FIG. 6.

Note that mill and fill is a process whereby the surface of a road is removed or milled (or grinded down). The area that is milled is then filled with a new road surface material, e.g., asphalt. Further note that pavement preservation is a process whereby a series of low-cost surface treatments are applied periodically to a road segment, at a minimum in good condition, halting further deterioration. Also, reconstruction is a process whereby the original template of the road segment 107 is changed, e.g., full depth reclamation. In one embodiment, the remote server 101 calculates life cycle information, including an adjusted useful life remaining. In this regard, the remote server may calculate the adjusted useful life remaining based upon data indicative of by adjusting the slope of the useful life portion of the life cycle curve thereby increasing or decreasing the remaining useful life of a road segment. In one embodiment, a theoretical RCI is defined by the user based on empirical data and is dependent on ADT ranges and surface types. If, for instance, the calculated RCI from a given inspection year is different (higher or lower) than the user defined RCI for that same inspection year, the remote server may calculate an adjusted useful life remaining based on the difference. The adjusted useful life remaining may be increased or decreased depending on the algebraic difference in the actual RCI and the user defined RCI for that point in time. The adjusted useful life remaining is given in years from the current calendar year and may be positive or negative. A negative adjusted useful life remaining would indicate that the road segment has already surpassed its useful life. A positive adjusted useful life remaining indicates the amount of time left for a road segment to reach the end of its useful life in the future. A positive adjusted useful life remaining may be limited by the user defined maximum adjusted useful life in years. For example, the user defined RCI for a given inspection year may be 78, but the actual RCI calculated may be 88, causing the adjusted useful life remaining to shift further into the future than expected, but not to exceed the user defined maximum adjusted useful life. If, however, the actual RCI is less than the expected RCI, the adjusted useful life would shift to a point in time less than expected and could be negative if it occurs prior to the current calendar year. This information may be provided to a user of the remote server 101, along with the other metrics to help refine the decision on whether to include a given road segment in the current repair budget or to delay repair for future consideration.

The remote server 101 displays to the user of the remote server 101 data upon which the user can determine what course to take in performing maintenance or reconstruction on the road segment 107. In this regard, the remote server 101 displays the adjusted useful life remaining and the cost scenarios for each course to take in performing maintenance or reconstruction. The user may then review road segment data for a plurality of road segments and based upon budget constraints, use characteristics, and other concerns decide whether to perform the maintenance or reconstruction.

Note that it is a subjective decision made by a user of the remote device 101 based upon objective data provided by the remote device 101 to set maintenance and construction priorities. For example, the basis for deciding whether to do repair or maintenance may be (1) data indicative of construction state number(s), (2) RCI (computed from construction state number(s) and user defined weights), (3) Priority Scores & Ranks (computed from RCI, ADT, Residences, Businesses and user defined weights), (4) Life Cycle data (Adjusted Useful Life Remaining), and (5) Cost Data (computed from automatically created or user-defined cost scenarios that include construction state numbers and user defined pay items).

In one embodiment, the remote server 101 may further display other considerations for use in decision-making. For example, the remote server 101 may display RCI, average daily traffic, number of residences (RES) affected by the road segment 107, or number of businesses (BUS) affected by the road segment 107. These factors may correspond to weights that are user-defined. For example, the user may give more weight to RCI, ADT, RES, or BUS described further with reference to FIGS. 7-9. Such weights are used in calculation of a priority score and rank calculated by the remote server 101 and stored as road segment priority data 312.

As an example, the raw RCI, ADT, RES, and BUS data are first converted to a percentile rank for each road segment. So, the RCI percentile rank may be 73.400 with a weight of 0.50 (user-defined from table), the ADT percentile rank may be 89.000 with a weight of 0.30, the RES percentile rank may be 92.700 with a weight of 0.10, and the BUS percentile rank may be 99.800 with a weight of 0.10. The remote server 101 calculates a priority score for the road segment 107 with the following calculation:

$$( 73.4 * 0.5 ) + ( 89. * 0.3 ) + ( 92.7 * 0.1 ) + ( 99.8 * 0.1 ) = 82.65$$

The remote server 101 performs the above calculation for each of the road segments to determine a priority score for each road segment 107. Considering the calculated priority scores, the remote server 101 may display to the user ranking 1−N (N=total number of segments). Thus, the user is informed which road segments based upon the user-defined weights and calculations have top priority or low priority. This information may be used by the user to determine which road segments should be prioritized for maintenance or construction in the current budget cycle.

FIG. 2 is a block diagram of an exemplary handheld device 104 in accordance with an embodiment of the present disclosure.

As shown by FIG. 2, handheld device 104 comprises at least a processor 200, a network interface 207, an input interface 206, an output interface 205, and memory 201. Stored in memory 201 is system controller 202. The system controller 202 may be software, hardware, firmware, or a combination thereof.

The exemplary embodiment of the handheld device 104 depicted by FIG. 2 comprises the processor 200, such as a Digital Signal Processor (DSP) or a Central Processing Unit (CPU), communicates to and drives the other elements within the handheld device 104 via a local interface 208, which can include at least one bus. Further, the processor 200 is configured to execute instructions of software, such as the system controller 202.

The system controller 202 controls the functionality of the handheld device 104, and the present disclosure describes in more detail hereafter. As noted above, the system controller 202 can be implemented in software, hardware, firmware, or any combination thereof. In an exemplary embodiment illustrated in FIG. 2, the system controller 202 is implemented in software and stored in memory 201.

Note that the system controller 202, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The input interface 206 may be, for example, a touch screen, a universal serial bus (USB), a keyboard, or a microphone. A passenger 102 (FIG. 1) may use one or more of the input interfaces 206 to input data into the handheld device 104. In this regard, the passenger 102 may use the touch screen, the keyboard, the USB, or microphone to enter data indicative of the construction state number described above as observed by the passenger 102 In one embodiment, photos or videos may be used to augment construction state number data by providing context or verification.

The output interface 205, for example, a display device (e.g. a Liquid Crystal Display (LCD), outputs data to the passenger 102 from the handheld device 104. In this regard, the system controller 202 may display to the passenger 102 graphical user interfaces (GUIs) configured to receive information for collecting the construction state number data as described above.

In addition, the network interface 207 such as a Network Interface Card (NIC) enables the handheld device 104 to communicate via the network 103 (FIG. 1) with the remote server 101 (FIG. 1).

The system controller 202 uses input from the passenger 102 related to construction states of a road segment 107 (FIG. 1). When the passenger 102 selects a construction state number for a particular section of the road segment 107, the system controller 202 receives latitude and longitude data from a global positioning system (GPS) 209. The system controller 202 monitors the data indicative of coordinates along the construction state number line segment. That is, for each construction state number entered for the road segment, the system controller associates in road segment data 203, each construction state number with its spatial information obtained from GPS 209. As will be described further, the data indicative of the section coordinates is used to determine the square yards of the section for which RRR may be selected. In one embodiment, the handheld device 104 receives coordinate pairs on regular intervals of time (e.g., every second). While a construction state number is selected on the handheld device 104, the system controller 202 uses each received coordinate pair to draw a line representing the construction state number. This way, it can create lines that follow the curvature of the road rather than straight lines.

After a road segment 107 has been completed, i.e., all construction state number(s) have been identified for each lane for each construction state number(s) of the road segment 107, the system controller 202 transmits the road segment data 203 to the remote server 101.

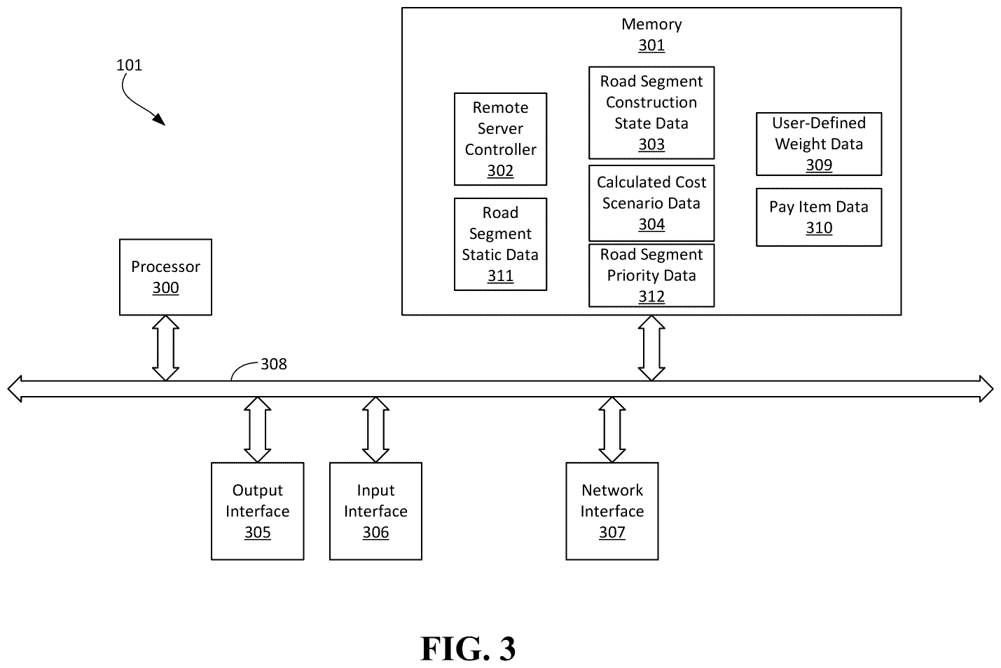

FIG. 3 is a block diagram of an exemplary remote server 101 in accordance with an embodiment of the present disclosure.

As shown by FIG. 3, remote server 101 comprises at least a processor 300, a network interface 307, an input interface 306, an output interface 305, and memory 301. Stored in memory 301 is remote server controller 302. The remote server controller 302 may be software, hardware, firmware, or a combination thereof.

The exemplary embodiment of the remote server 101 depicted by FIG. 3 comprises the processor 300, such as a Digital Signal Processor (DSP) or a Central Processing Unit (CPU), communicates to and drives the other elements within the remote server 101 via a local interface 308, which can include at least one bus. Further, the processor 300 is configured to execute instructions of software, such as the remote server controller 302.

The remote server controller 302 controls the functionality of the remote server 101, and the present disclosure describes in more detail hereafter. As noted above, the remote server controller 302 can be implemented in software, hardware, firmware, or any combination thereof. In an exemplary embodiment illustrated in FIG. 3, the remote server controller 302 is implemented in software and stored in memory 301.

Note that the remote server controller 302, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The input interface 306 may be, for example, a touch screen, a universal serial bus (USB), a keyboard, or a microphone. A user (not shown) of the remote server 101 may use the input interface 306 to input data into the remote server 101. In this regard, the user may use the touch screen, the keyboard, the USB, or microphone to enter data indicative of a selection of a cost scenario or the like. Also, the input interface 306 may be a camera (not shown) that receives images.

The output interface 305, for example, a display device (e.g., a Liquid Crystal Display (LCD)), outputs data to the user of the remote server 101. In this regard, the remote server controller 302 may display to the user graphical user interfaces (GUIs) configured to receive information for collecting information such as a selection of a cost scenario.

In addition, the network interface 307 such as a Network Interface Card (NIC), enables the remote server 101 to communicate via the network 103 (FIG. 1) with the handheld device 104 (FIG. 1).

In operation, the remote server controller 302 receives road segment construction state data 303 from the handheld device 104 via the network interface 307. The road segment construction state data 303 comprises data indicative of construction state number(s) for at least one road segment and associated coordinates defining a line for the construction state number. The system controller 202 stores the road segment construction state data 303 in memory 301. As described above, the remote server controller 302 calculates various metrics based upon the road segment construction state data 303 and presents calculated cost scenario data 304 to the user.

Note that there is pay item data 310 associated with each construction state that the remote server 101 uses in the conversion of road segment construction state data 303 to the various metrics needed for decision-making. Road segment static data 311 is mutually exclusive of road segment construction state data 303. The remote server controller 302 calculates the square yards for a section of the road segment 107 (FIG. 1) by multiplying the length (ft) of the road segment by the width (ft) of the road segment, then dividing by 9. Furthermore, the server controller 302 calculates the square yards for construction state number(s) 1-4 by multiplying the length (ft) of the individual construction state by the corresponding lane width (ft) of the road segment, then dividing by 9. construction state number 5 remains a linear feet measurement and is not converted to square yards. After the conversion process is complete, the remote server controller 302 calculates quantities of labor and materials that are used to produce a cost estimate for each road segment. In this regard, the remote server controller 302 may calculate various cost scenarios that include REPAIR ONLY, PP, M&F, or RECONSTRUCTION based upon the construction state number(s) and conversions.

Note that the remote server 101 further comprises road segment static data 311. The road segment static data 311 is prepopulated data related to the road segment and may be used in calculations related to cost scenarios or other metrics. For example, the road segment static data 311 may contain a road segment identifier, the name of the road segment (e.g., First Street, Joshua Drive, Hollow Way, Highway 72, etc.), the width of the road segment, and the like.

For example, the total square yardage calculated for the road segment may be 11,631 square yards and the road segment may have a total length of 5,254 feet. For the road segment 10 there may be 6,827.0 square yards for construction state number 1, 1,306.9 square yards for construction state number 2, 1,136.4 square yards for construction state number 3, 167.4 square yards for construction state number 4, and 117.4 linear feet for construction state number 5. The remote server controller 302 calculates an average construction state number with the following:

((6,8270/11,631)*1)+((1,306.9/11,631)*2)+((1,136.4/11,631)*3)+((167.4/11,631)*4)+((117.4/(2*5,254))*5)=1.22,

which is a number indicative of the average construction state for the road segment 107. The average construction state number for the road segment 107 may be displayed via output interface 305 to the user so that the user may use the average construction state number, as an additional metric, to determine whether the road segment is to be repaired or maintained.

Further, the remote server controller 302 calculates cost scenarios from the cost scenario pay item data 310 and the various conversions. In this regard, the remote server controller 302 calculates a repair only cost scenario, a PP cost scenario, a M&F cost scenario, and/or a reconstruction cost scenario for each road segment 107 and stores the data indicative of each cost scenario as cost scenario data 304. This information is presented to the user via the output interface 305.

Using the input interface 306, the user may consider the information displayed to determine which road segments to address. In this regard, the user may consider the priority rank of each road segment and the cost scenario for each road segment to determine for which road segment action will be taken and what action will be taken.

FIG. 4 is a diagram of an exemplary road segment illustrating exemplary construction state number(s) recorded by a passenger 102 (FIG. 1) as shown in FIG. 1 of the road segment 107.

The road segment 107 comprises four lanes, including lanes 400-403 having total length 423. Each lane 400-403 has an effective lane width 404-407, respectively. FIG. 4 illustrates five construction state number(s)(CS1-CS5) as further described in FIG. 5. In this regard, an integer 1-5 correlates to a description of defects that may be present in the road segment 107. Data for each of the construction states present in the road segment 107 has been captured and stored as line segments 408-412. Note that the line segments 408-412 are shown in colors blue, orange, yellow, green, and red to correspond to the construction state number(s) listed in FIG. 5.

Notably, the passenger 102 perceived roadway section loss resulting in narrowing of lane widths, which is categorized as construction state number 5. While driving along the road segment 107 and upon the recognition of the construction state number 5 defects 418, the passenger entered construction state number 5 (FIG. 5) in the handheld device 104. Upon entering the construction state number, the handheld device 104 began to capture coordinates defining a line 408 (shown in blue) extending along the construction state number 5 defects 418 evidenced. In one embodiment, the passenger 102 (or other user) may configure the handheld device 104 to capture coordinates based upon time (e.g. every five seconds), based upon distance (e.g. every five feet), or other parameter. When the passenger 102 perceives that the defects 418 associated with construction state number 5 have ended, the passenger 102 ends the construction state number coordinate capturing via the handheld device 104. The linear feet 413 of construction state number 5 defect 418 is shown in FIG. 4.

Further, the passenger 102 perceived densification and/or minor rutting, which is categorized as construction state number 3. While driving along the road segment 107 and upon the recognition of the construction state number 3 defects 419, the passenger entered construction state number 3 (FIG. 5) in the handheld device 104. Upon entering the construction state number, the handheld device 104 began to capture coordinates defining a line 409 (shown in orange) extending along the construction state number 3 defects 419 evidenced. When the passenger 102 perceives that the defects 419 associated with construction state number 3 have ended, the passenger 102 ends the construction state number coordinate capturing via the handheld device 104. The linear feet 414 of construction state number 3 defects 419 are shown in FIG. 4.

Additionally, the passenger 102 perceived moderate issues and/or extensive cracking, which is categorized as construction state number 2. While driving along the road segment 107 and upon the recognition of the construction state number 2 defects 420, the passenger 102 entered construction state number 2 (FIG. 5) in the handheld device 104. Upon entering the construction state number, the handheld device 104 began to capture coordinates defining a line 410 (shown in yellow) extending along the construction state number 2 defect 420 evidenced. When the passenger 102 perceives that the defects 420 associated with construction state number 2 have ended, the passenger 102 ends the construction state number coordinate capturing via the handheld device 104. The linear feet 417 of construction state number 2 defects 420 are shown in FIG. 4.

The passenger 102 also perceived minor issues and/or minor cracking, which is categorized as construction state number 1. While driving along the road segment 107 and upon the recognition of the construction state number 1 defects 421, the passenger 102 entered construction state number 1 (FIG. 5) in the handheld device 104. Upon entering the construction state number, the handheld device 104 began to capture coordinates defining a line 412 (shown in green) extending along the construction state number 1 defects 421 evidenced. When the passenger 102 perceives that the defects 421 associated with construction state number 1 have ended, the passenger 102 ends the construction state number coordinate capturing via the handheld device 104. The linear feet 416 of construction state number 1 defects 421 are shown in FIG. 4.

The passenger 102 perceived structural failure and/or total surface failure, which is categorized as construction state number 4. While driving along the road segment 107 and upon the recognition of the construction state number 4 defects 422, the passenger 102 entered construction state number 4 (FIG. 5) in the handheld device 104. Upon entering the construction state number, the handheld device 104 began to capture coordinates defining a line 411 (shown in red) extending along the construction state number 4 defects 422 evidenced. When the passenger 102 perceives that the defects 422 associated with construction state number 4 have ended, the passenger 102 ends the construction state number coordinate capturing via the handheld device 104. The linear feet 415 of construction state number 4 defects 422 are shown in FIG. 4.

In one embodiment, the construction state number line segments captured are stored as line segments 408-412 measured in linear feet. Other dimensions of the road segment are shown, such as total segment length (TL) 423, effective lane width (EL) 404-407. The effective surface area (ESA) is computed by the remote server 101 (FIG. 1) and is used by the remote server 101 to compute a road construction index (RCI) and associated cost estimates, which is described further herein. The remote server 101 sums all linear measurements, in feet, of construction states 408-412 and converts construction states 409-412 to an area in square yards as shown below:

$$CS 1 AREA ( SY ) = [ ( \sum CS 1 ( FT ) ) * ( EL ( FT ) ) ] / 9$$

$$CS 2 AREA ( SY ) = [ ( \sum CS 2 ( FT ) ) * ( EL ( FT ) ) ] / 9$$

$$CS 3 AREA ( SY ) = [ ( \sum CS 3 ( FT ) ) * ( EL ( FT ) ) ] / 9$$

$$CS 4 AREA ( SY ) = [ ( \sum CS 4 ( FT ) ) * ( EL ( FT ) ) ] / 9$$

$$CS 5 LEN ( FT ) = \sum CS 5 ( FT ) ,$$

where CS(X)AREA is the area of the defects for each construction state number x, where x=1-4. For each construction state number 1-4 the linear feet of each construction state is summed ΣCS(X), where x=1-4, multiplied by their respective lane widths EL(X), where x=1-4, and divided by nine (9) to convert the feet to square yards. Note that construction state number 5 is an exception in that only the length is regarded in determining RCI and cost scenarios. In this regard, the length of the line associated with construction state number 5 is equal to the sum of the linear feet of the construction state number 5 lines collected ΣCS5.

FIG. 6 is a table 600 listing exemplary pay items that may be used and/or selected by the user in determining a cost scenario for construction state number 4 defects(s) found in a road segment 107 (FIG. 1). Note that the table 600 is merely exemplary, and other pay items may be used for other construction state numbers in other embodiments.

Regarding table 600, a pay item description is given, e.g., spot milling−deep (>2.5″). Units are associated with the pay item, e.g., square yards or tons. A rate type is associated with each pay item, e.g., contract, materials only, or other (e.g., federal emergency management agency (FEMA) rates). Other characteristics may also appear in the table 600, including pounds per square yard, depth of defect, length of defect, and width of defect. A quantity is provided and multiplied by the rate type to arrive at a total cost for the pay item listed.

Note that when determining cost scenarios, which is described further herein, the total costs for each pay item are used. In one embodiment, the pay items listed may be selected by a user of the remote server 101 when calculating a user-defined RRR cost scenario.

FIGS. 7-9 are tables 700-900 that show exemplary user-defined weights that may be used in calculations of adjusted life remaining related to the road segment 107 (table 700), road construction index of a road segment (table 800), and priority score weights (table 900). These weights are described further herein.

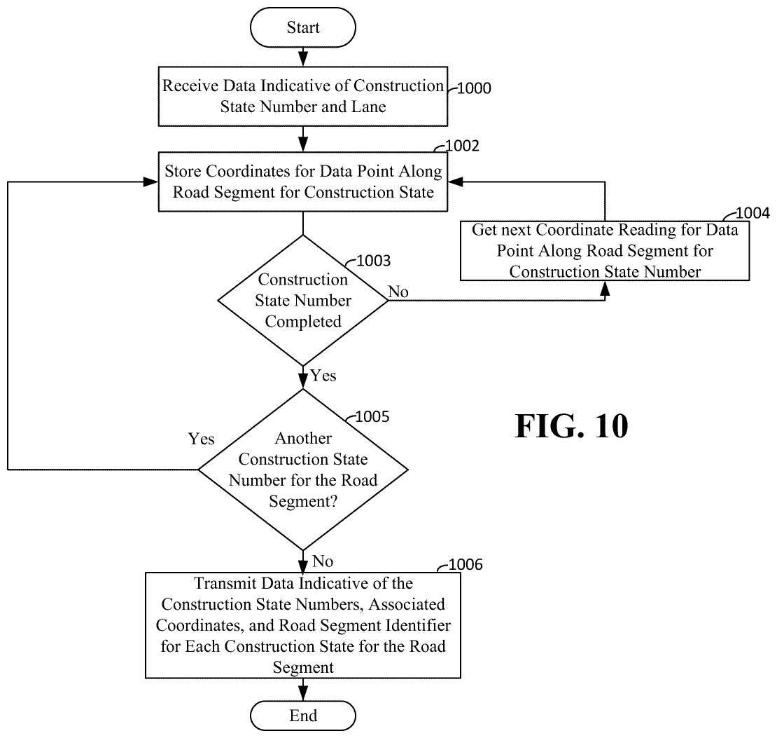

FIG. 10 is a flowchart of exemplary architecture and functionality of the handheld device 104 (FIG. 1).

In step 1000, a passenger 102 (FIG. 1) enters a road segment identifier (e.g., numeric or alphanumeric identifiers), a construction state number, and a lane identifier for which road segment construction state data 303 (FIG. 3) is to be entered by the passenger 102. The road segment identifier may be obtained electronically, e.g., from a map displayed to the passenger, or the passenger 102 may have obtained the road segment identifier prior to collection of road segment defect data. The construction state number defines identified or perceived defects in the road segment 107 (FIG. 1) Note that the handheld device 104 may be, for example, a smartphone or a tablet. The construction state number entered in the handheld device 104 is subjectively determined by the passenger 102 (FIG. 1). These construction state numbers 1-5 are shown in table 500 (FIG. 5). The one or more construction state numbers entered associate with specific distresses or defects so that specific remedial processes may be identified by the remote server when determining cost scenarios.

In step 1002, the system controller 202 stores coordinates indicative of data points along the road segment construction state number obtained from a global positioning system (GPS) 209 (FIG. 2) on the handheld device. Until the passenger indicates an ending for the road segment construction state number in step 1003, the handheld device 104 gets a next coordinate for another data point along the road segment, as the vehicle 105 travels, from the GPS as indicated in step 1004. The system controller 202 associates the coordinate pairs with the construction state number selected. Note that the coordinate pairs may be in the form of latitude and longitude, state plane, or other coordinate system.

Once the construction state number is completed in step 1003, the passenger may enter another perceived construction state number in the handheld device 104 in step 1005. If the passenger enters another construction state number in step 1005, the handheld 104 continues steps 1002-1004 until each construction state number entered is completed.

Upon completion of the road segment, i.e., one or more constructions state numbers have been entered and coordinate pairs for each construction state number recorded, the handheld device 104 transmits data indicative of the one or more construction state numbers, associated coordinates, lane information, and road segment identifier to the remote server 101 in step 1006.

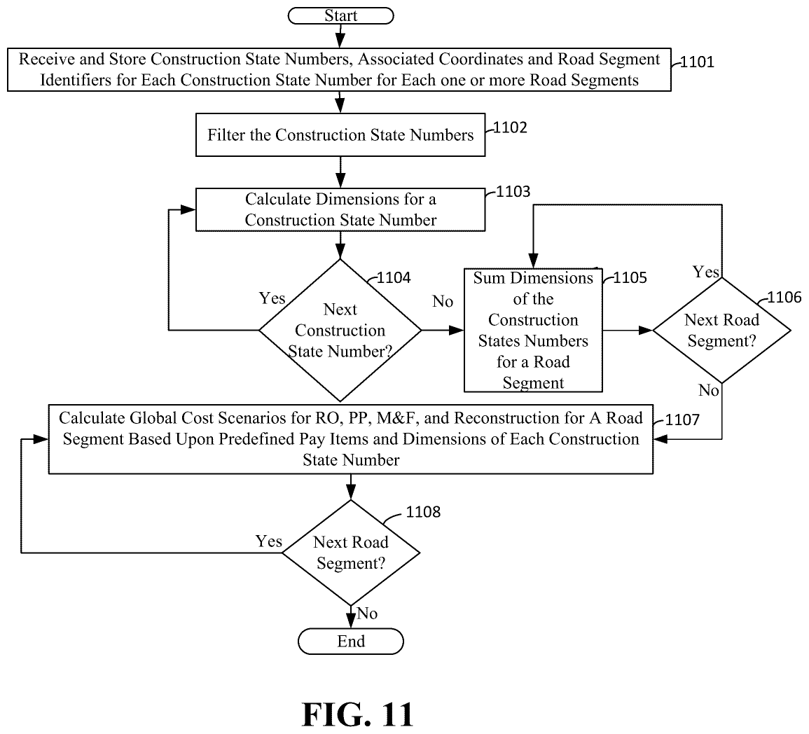

FIG. 11 is a flowchart of exemplary architecture and functionality of the remote server 101 (FIG. 1) for calculating global cost scenarios.

In step 1101, the remote server controller 302 (FIG. 3) receives and stores the construction state numbers, associated coordinates, and road segment identifiers for each construction state number for each one or more road segments. The data indicative of each construction state number and its associated coordinate pairs and lanes for each construction state number and each road segment may be received via the network 103 (FIG. 1) from the handheld device 104 (FIG. 1).

In step 1102, the remote server controller 302 filters the received construction state numbers. Note that each construction state number received is associated with one or more construction state numbers for a road segment.

In step 1103, the remote server controller 302 calculates dimensions for each construction state number, i.e., construction state 1-5. In step 1104, the remote server controller 302 determines if there is a next construction state number, i.e., construction state number 1-5. If there is another construction state number in step 1104, the remote server controller 302 calculates dimensions for the next construction state number in step 1103. This method continues (steps 1103 and 1104) until dimensions for all construction state numbers have been calculated.

When all construction state number dimensions have been calculated in step 1104, the remote controller 302 calculates a sum of the dimensions for each construction state number (in step 1104) for each road segment. If there is another road segment in step 1106, the remote server controller 302 continues this process (steps 1105-1106) until a sum has been calculated for each road segment in step 1105.

When the remote server controller 302 determines that there is no next road segment in step 1106, the remote server controller 302 calculates global cost scenarios for RO, PP, M&F, and Reconstruction for each road segment based upon predefined pay items and calculated dimensions of each construction state number of the road segment in step 1107. Note that for construction state numbers 1-4 the units of the dimensions may be square yards, whereas the units for construction state number 5 may be linear feet. In this regard, for construction state number 5, linear feet are used to determine edge repair costs for RO, PP, M&F an d R CON.

When the remote server controller 302 has calculated global cost scenarios for a road segment in step 1107, the remote controller 302 determines whether there is a next road segment in step 1108. If there is another road segment in step 1108, the remote server controller 302 continues this process (steps 1107-1108) until a global cost scenario has been calculated for each road segment in step 1105.

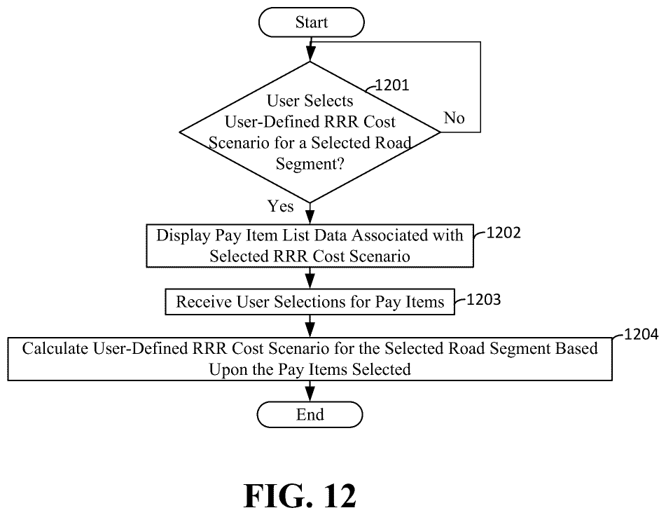

FIG. 12 is a flowchart exhibiting exemplary architecture and functionality of the remote server controller 302 calculating a user-defined cost scenario for the system as shown in FIG. 1.

In step 1201, the user may elect to create a user-defined RRR cost scenario for a selected road segment. If the user elects to create a user-defined RRR cost scenario in step 1201, the remote server controller 302 displays a pay item list data associated with the selected RRR cost scenario, i.e., RO, PP, M&F and RCON, in step 1202.

In step 1203, the remote server controller 302 receives data indicative of the user-selected pay items. In step 1204, the remote server controller 302 calculates a user-defined RRR cost scenario for the selected road segment based upon the pay items received in step 1203.

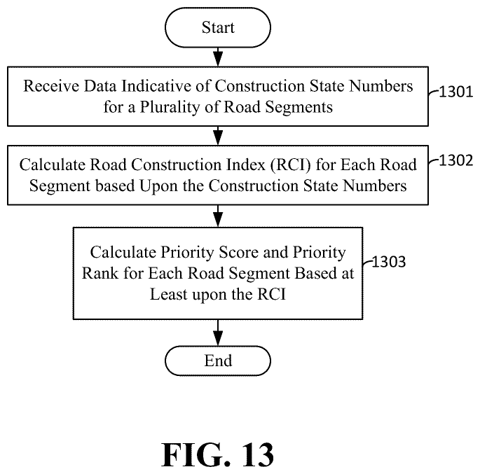

FIG. 13 is a flowchart of exemplary architecture and functionality of the remote server 101 (FIG. 1) relating to prioritizing road segments based upon metrics received or calculated by the remote server controller 302. In one embodiment, the prioritization may be based upon, at least, construction state numbers and a calculated RCI.

In step 1301, the remote server controller 302 receives data indicative of construction state numbers for a plurality of road segments. This data may be provided by the handheld device 104 (FIG. 1) via the network 103 (FIG. 1) as described hereinabove with reference to FIG. 4.

In step 1302, the remote server controller 302 calculates a road construction index (RCI) for each road segment. Calculation of an RCI for each road segment is described hereinabove. In one embodiment, the RCI is calculated based upon construction state numbers. In another embodiment, the RCI may be calculated using ADT, numbers of businesses, and/or number of residences.

In step 1303, the remote server controller 302 calculates priority score and priority rank for each road segment based at least upon the RCI calculated.

What we claim is:

1. An infrastructure management system, comprising:
a handheld device, the handheld device configured for receiving data indicative of one or more construction state numbers of one or more road segments, the construction state numbers identifying repair characteristics for classifying the one or more road segments for repair;
a global positioning system (GPS) integral with or in communication with the handheld device, the GPS configured for recording coordinates of the handheld device for the one or more construction state numbers;
a processor configured for receiving data indicative of the one or more construction state numbers of the one or more road segments and coordinates for the construction state numbers, the processor further configured for calculating dimensions of the one or more construction state numbers based upon the coordinates, the processor further configured for calculating at least one cost scenario for each of the one or more road segments based upon the one or more construction state numbers and the calculated dimensions.

2. The infrastructure management system of claim 1, wherein the handheld device is a smartphone.

3. The infrastructure management system of claim 1, wherein the handheld device is a tablet.

4. The infrastructure management system of claim 1, further comprising a network, wherein the handheld device is further configured for transmitting the data indicative of the construction state numbers of the one or more road segments and the coordinates for the construction state numbers for the one or more road segments via a wireless network to a remote server.

5. The infrastructure management system of claim 1, wherein the remote server comprises a remote server processor, the remote server processor configured for calculating at least one cost scenario for repair, pavement preservation, mill and fill, and/or reconstruction for the one or more road segments based upon the construction state numbers and the dimensions associated with the construction state numbers.

6. The infrastructure management system of claim 1, wherein the remote server comprises a remote server processor, the remote server processor configured for calculating an average construction state number for each of the one or more road segments.

7. The infrastructure management system of claim 6, wherein the remote server processor is further configured for calculating a road construction index (RCI) for each of the one or more road segments based upon the data indicative of the average construction state number.

8. The infrastructure management system of claim 7, wherein the remote server processor is further configured for calculating a priority score for each RCI of the one or more road segments.

9. The infrastructure management system of claim 7, wherein the processor is farther configured for calculating adjusted remaining life based upon data indicative of the RCI.

10. The infrastructure management system of claim 7, wherein the remote server processor is further configured for calculating the RCI based upon the number of businesses affected by the road segment.

11. The infrastructure management system of claim 7, wherein the remote server processor is further configured for calculating the RCI based upon the number of residences affected by the road segment.

12. The infrastructure management system of claim 1, wherein the processor is configured for calculating the cost scenario based upon multiplying one or more metric(s) used by the processor to calculate the at least one cost scenario by user-defined pay items.

13. The infrastructure management system of claim 1, wherein the processor is further configured for calculating the at least one cost scenario based upon predetermined cost scenario pay item data.

14. An infrastructure management method, comprising:
receiving, by a handheld device, data indicative of one or more construction state numbers of one or more road segments, the one or more construction state numbers identifying characteristics for classifying the one or more road segments for repair;
recording, by a handheld processor, coordinates of the handheld device for the one or more construction state numbers;
receiving data, by a remote server processor, data indicative of the one or more construction states of the one or more road segments and coordinates defining the one or more construction states.
calculating, by the remote processor, dimensions for the one or more construction state numbers based upon the coordinates recorded; and
calculating, by the remote server processor, one or more cost scenarios for the one or more road segments based upon the pay items and the dimensions of the one or more construction state numbers.

15. The infrastructure management method of claim 14, wherein the pay items are predefined.

16. The infrastructure management method of claim 14, wherein the pay items are selected by a user.

17. The infrastructure management method of claim 14, further comprising transmitting, by the handheld device, the data indicative of the one or more construction state numbers of the road segment and the coordinates via a wireless network to a remote server.

18. The infrastructure management system of claim 17, further comprising calculating, by the remote server, a cost scenario for repair, pavement preservation, mill and fill, and/or reconstruction for the road segment based upon the one or more construction state numbers and the dimensions.

19. The infrastructure management method of claim 14, further comprising calculating, by the remote server processor, a road construction index (RCI) for each of the one or more road segments based upon the data indicative of the one or more construction state numbers.

20. The infrastructure management system of claim 19, further comprising calculating, by the remote server processor, a priority score for each RCI of the one or more road segments.

21. The infrastructure management system of claim 19, wherein the processor is further configured for calculating an adjusted remaining life based upon data indicative of an RCI for each of the one or more road segments.

22. The infrastructure management system of claim 7, further comprising calculating, by the server processor, the RCI based upon the number of businesses affected by the road segment.

23. The infrastructure management system of claim 7, further comprising calculating, by the server processor, the RCI based upon the number of residences affected by the road segment.

24. The infrastructure management method of claim 19, further comprising displaying a prioritized list to a user of the remote server based upon the RCI.

25. The infrastructure management method of claim 19, further comprising calculating, by the remote server processor, the at least one cost scenario based upon user-defined pay item data.

26. The infrastructure management method of claim 19, further comprising calculating, by the remote server processor, the at least one cost scenario based upon predetermined cost scenario pay item data.
